(19) United States
(12) Patent Application Publication
(10) Pub. No.: US 2011/0314412 A1
(43) Pub. Date: Dec. 22, 2011

(54) COMPOSITING APPLICATION CONTENT AND SYSTEM CONTENT FOR DISPLAY

(75) Inventors: Rob Aldinger, Seattle, WA (US); Andrew Dadi, Seattle, WA (US); Thomas W. Getzinger, Redmond, WA (US); J. Andrew Goossen, Issaquah, WA (US); Jason Matthew Gould, Woodinville, WA (US)

(73) Assignee: Microsoft Corporation, Redmond, WA (US)

(21) Appl. No.: 12/818,082

(22) Filed: Jun. 17, 2010

(51) Int. Cl. G06F 3/048

(52) U.S. Cl. 715/781

(57) ABSTRACT

Application content and system content are composited to create composited frames for display by drawing foreground application content into an application buffer, building a reconstruction buffer, drawing system user interface content on top of the foreground application content in the application buffer, and displaying a composited frame by sending the application buffer directly to display hardware for display. The reconstruction buffer contains portions of the foreground application content copied from the application buffer. When system user interface content is being updated, the reconstruction buffer is used to recreate the original foreground application content. Updated system user interface content and original foreground application content are then used to create additional composited frames for display.

### BACKGROUND

Mobile devices often display both application graphical content and system graphical content (such as system status information) on the display at the same time. Displaying both types of content at the same time can be problematic, particularly on mobile devices with limited processing capacity.

In some situations, an application running on a mobile device will reserve portions of the display for system user interface content. For example, the application will only draw into specific areas of the display, leaving other areas of the display free for system content. However, this procedure places a burden on the application because the application must keep track of the areas where the system content will be drawn and adjust its output accordingly. Furthermore, this procedure constrains the output options of the application because the application cannot use the entire display area to render its content.

In other situations, an application running on a mobile device will render its content into a first buffer. Next, the system will copy the first buffer to a second buffer where the system will render its user interface. The system will display from the content in the second buffer. This procedure, while straightforward, suffers from performance issues. For example, it requires the first buffer to be copied to the second buffer each time the application is drawing a new frame.

Therefore, there exists ample opportunity for improvement in technologies related to displaying both application content and system content at the same time.

### SUMMARY

A variety of technologies related to compositing application content and system content for display are applied.

For example, a method is provided for compositing application content and system content to create composited frames for display by drawing foreground application content into an application buffer, building a reconstruction buffer, drawing system user interface content on top of the foreground application content in the application buffer, and displaying a composited frame by sending the application buffer directly to display hardware for display. The reconstruction buffer contains portions of the foreground application content copied from the application buffer. In a specific implementation, the method further comprises copying the application buffer to an original application content buffer and copying the content of the reconstruction buffer into the original application content buffer, where the original application content buffer, after copying the content of the reconstruction buffer, contains only the foreground application content.

A method for creating a reconstruction buffer comprises identifying areas of the application buffer where the system user interface content will be drawn. Once the areas have been identified, foreground application content from the application buffer is copied to the reconstruction buffer for the identified areas. The reconstruction buffer, after the copying, contains foreground application content only for the identified areas where the system user interface content will be drawn.

As another example, a computing device, such as a mobile device, is provided for compositing application content and system content to create composited frames for display. The computing device comprises a display and a processing unit. The processing unit is configured for performing operations comprising: drawing foreground application content into an application buffer, building a reconstruction buffer, where the reconstruction buffer contains portions of the foreground application content copied from the application buffer, drawing system user interface content on top of the foreground application content in the application buffer, and displaying, by the computing device on the display, a composited frame by sending the application buffer directly to display hardware of the computing device for display.

In another example, a first composited frame is created for display (e.g., as an application-driven update) on a computing device by drawing foreground application content into an application buffer, building a reconstruction buffer, where the reconstruction buffer contains portions of the foreground application content copied from the application buffer, drawing system user interface content on top of the foreground application content in the application buffer, and displaying, by the computing device, the first composited frame by sending the application buffer directly to the display hardware of the computing device for display. A second composited frame is created for display (e.g., as a system-driven update) by copying the application buffer (that was previously displayed) to an original application content buffer, copying the content of the reconstruction buffer into the original application content buffer, where the original application content buffer, after copying the content of the reconstruction buffer, contains only the foreground application content, copying the original application content buffer to a new application buffer, drawing updated system user interface content into the new application buffer, and displaying, by the computing device, a second composited frame by sending the new application buffer directly to the display hardware of the computing device for display.

The foregoing and other features and advantages of the invention will become more apparent from the following detailed description, which proceeds with reference to the accompanying figures.

### BRIEF DESCRIPTION OF THE DRAWINGS

FIG. 1 is a flowchart showing an exemplary method for compositing application content and system content to create a composited frame for display.

FIG. 2 is a flowchart showing an exemplary method for building a reconstruction buffer.

FIG. 3 is a flowchart showing an exemplary method for updating system user interface content without updating application content.

FIG. 4 is a diagram showing example buffers for compositing application content and system content for display.

FIG. 5 is a diagram showing example buffers for updating system user interface content without updating application content.

FIG. 6 is a block diagram showing an example mobile device.

FIG. 7 is a diagram showing an example implementation environment.

### DETAILED DESCRIPTION OF EXEMPLARY EMBODIMENTS

The following description is directed to techniques and solutions for compositing application content and system content for display. The various techniques and solutions can be used in combination or independently. Different embodiments can implement one or more of the described techniques and solutions.

I. Example Application Content

In the techniques and solutions described herein, a software application running on a computing device produces application content (graphical content, which includes text, graphics, video, icons, buttons, pictures, or any other type of application content that can be displayed on a display, such as a liquid crystal display (LCD), of a computing device). When the application is the foreground application, its content will be displayed by the computing device on the computing device's display. For example, a video game application, when it is the foreground application, will display frames of video game content on the display of the computing device. Similarly, other types of applications (e.g., email applications, photo applications, music applications, etc.) will display their content on the display of the computing device when they are the foreground application.

Application content can also be system-related content, such as content produced by operating system software or other system related software. For example, the foreground application can also be the system or operating system.

In some implementations, application content or foreground application content refer to application content produced by one or more (e.g., a plurality of) applications (system or operating system applications and/or non-system applications). For example, a number of applications can produce application content (e.g., a number of application layers) that is composited together. System user interface content can then be drawn on top of the resulting application content (the composited content of the multiple applications).

In a specific implementation, the foreground application displays its content by drawing (e.g., writing or rendering) content into a buffer (called an “application buffer” for ease of identification when discussing various buffers holding different types of content).

II. Example System User Interface Content

In the techniques and solutions described herein, system user interface (UI) content is graphical user interface (GUI) content produced by a computing device (e.g., produced by software, such as operating system software, and/or hardware of the computing device). An example of a device capable of producing system user interface content is a mobile computing device (e.g., a cell phone, mobile phone, smart phone, or another type of mobile computing device).

Various types of system user interface content can be drawn (e.g., written or rendered) on top of application content (e.g., as an overlay). For example, a mobile phone device operating system can draw system user interface elements, such as date and time, remaining battery charge, wireless signal strength, etc., on top of application content (e.g., in an application buffer). System user interface content includes text, static graphics, animations, icons, alpha blended content, etc.

In some implementations, system user interface content refers to user interface content produced by one or more (e.g., a plurality of) system applications and/or system components. For example, a number of system applications can produce system user interface content (e.g., a number of system user interface content layers) that is composited together. The system user interface content can then be drawn on top of the application content.

III. Example Displaying Composited Frames

In the techniques and solutions described herein, composited frames are displayed by compositing foreground application content (graphical user interface (GUI) content produced by a software application) and system user interface content. Various techniques are used to improve the efficiency of displaying composited frames. In a specific implementation, foreground application content is drawn into an application buffer and system user interface content is drawn on top of the foreground application content (e.g., as an overlay) in the same application buffer. The application buffer is then displayed directly (without making another copy of the application buffer) as a composited frame.

In some implementations, a compositor (part of the graphics system of a computing device) works with applications running on the computing device to produce composited frames for display. The compositor maintains a set of buffers that are sent directly to the display hardware of the computing device for display. The foreground application (one of the applications running on the computing device that currently has control of, or exclusive access to, the display) obtains one of the buffers (called the “application buffer”) from the compositor (e.g., via an application programming interface (API) provided by the graphics system) to render (e.g., draw or write using graphics commands via the API) its content into the application buffer for display. Once the foreground application renders its content into the application buffer, the compositor draws the current system user interface content on top of the foreground application content in the application buffer. As part of the same step of drawing the current system user interface content (e.g., system status information such as battery strength, signal strength, and/or date and time), the areas where the current system user interface content will overlay the foreground application content are copied (e.g., saved) into another buffer, called the “reconstruction buffer.” The compositor then sends the application buffer (with the foreground application content and the system user interface content) directly to the display hardware for display.

Providing the application buffer directly to the display hardware for display (without making another copy of the application buffer) is more efficient than alternative approaches. For example, providing the application buffer directly is more efficient than copying the application buffer to another buffer first because it avoids an additional memory copy. Depending on the implementation, efficiencies include reduced processor cycles, reduced memory usage, and reduced power usage.

Creating the reconstruction buffer also provides efficiencies. For example, using the reconstruction buffer the compositor is able to update the system user interface content independently of the foreground application. This is accomplished by copying the contents of the previously presented frame (the application buffer with the foreground application content and system user interface content that was previously presented for display), copying the contents of the reconstruction buffer on top in order to restore the original foreground application content, and then rendering the updated system user interface content on top. In this situation, the restored original foreground application content can be cached (e.g., saved) before the updated system user interface content is drawn on top. The cached original foreground application content can then be used for subsequent frames where the system user interface content is being updated but the foreground application content remains the same.

In some implementations, the above techniques allow the foreground application to drive the frequency with which the display is updated (the framerate). The foreground application controls the framerate by requesting new buffers and drawing its content at a rate the foreground application controls. This allows applications, such as graphics-intensive applications (e.g., games), to run at their natural framerate.

In some situations, the compositor imposes a minimum framerate (e.g., a minimum acceptable framerate) for the foreground application to produce new frames for display. If the foreground application falls below the minimum framerate (e.g., a threshold value), then the compositor will take over and update the system user interface content more frequently, using the reconstruction buffer discussed above. In some circumstances, updating system user interface content when the foreground application falls below a minimum framerate provides for a more responsive user interface experience for the user. For example, the system user interface content remains responsive and provides visual feedback even when the foreground application is unresponsive (e.g., updating slowly).

Furthermore, the technique of drawing foreground application content into the application buffer and then drawing system user interface content on top of the foreground application content in the application buffer provides flexibility. For example, any type of system user interface content (e.g., static graphics, animations, icons, alpha blended content, etc.) can be drawn on top of the foreground application content. The foreground application does not need to worry about reserving space for system user interface content, as the system user interface content will be drawn independently on top (e.g., as an overlay).

In a specific implementation, the foreground application is given exclusive control (in relation to other applications running on the device) of the graphics resources without the foreground application being aware of the exclusive control. The system is able to draw system user interface content after the foreground application has drawn its content, without the foreground application being aware of the system user interface content being drawn on top (e.g., from the foreground application's point of view, it has full control over the fullscreen display).

In some situations, it is desirable to make a copy of the application buffer before sending it to the graphics hardware for display. For example, during a transition between display of two applications (e.g., where a first application is coming to the foreground and a second application is going to the background), various transforms may need to be applied (e.g., to apply perspective). In this situation, the application buffer is copied to a new buffer, the transform is applied to the new buffer, and the new buffer is sent to the graphics hardware for display.

IV. Example Methods for Compositing Application and System Content

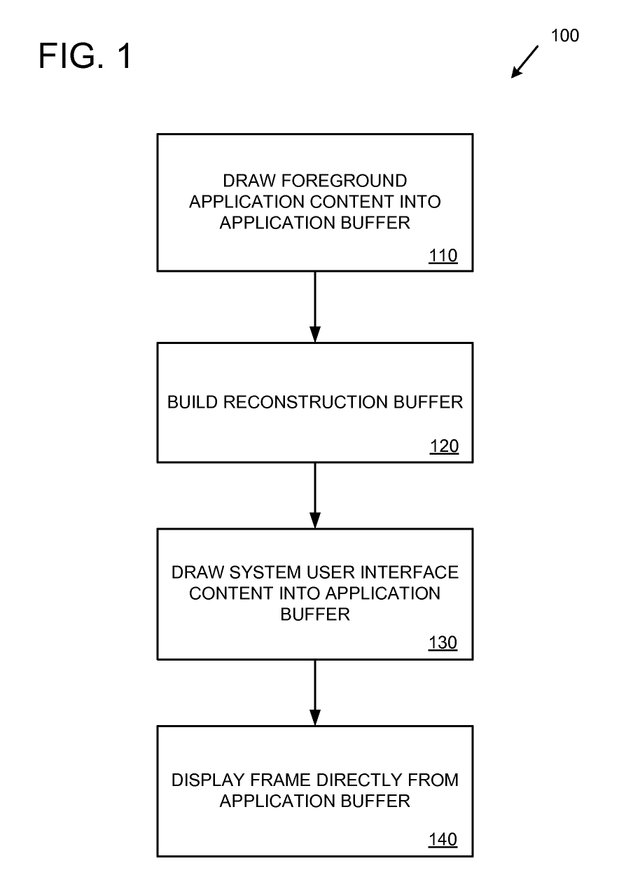

FIG. 1 shows an exemplary method 100 for compositing application content and system content to create a composited frame for display. At 110, the foreground application draws its content into an application buffer. The type of graphical content drawn by the foreground application depends on the application. For example, an email application could produce content such as text labels (e.g., “To:” “From:” and “Subject:”) and entry fields. A movie player application could produce frames of video content.

In a specific implementation, the foreground application draws application content using operations (e.g., rendering operations) via a graphics application programming interface (API) provided by the system software of the computing device upon which it is running. One example of such a graphics API is the Direct3D® API provided by Microsoft®.

At 120, a reconstruction buffer is built. The reconstruction buffer contains portions of the foreground application content that has been copied from the application buffer. Using the content in the reconstruction buffer, the original foreground application content can be reconstructed when needed.

In a specific implementation, the reconstruction buffer is built by identifying areas (e.g., using bounding rectangles) of the application buffer where system user interface content will be overlaid. The foreground application content for the identified areas is then copied from the application buffer to the reconstruction buffer. In a typical usage scenario, only small areas of the application buffer will be overlaid with system user interface content. Therefore, only small areas of the foreground application content will need to be copied from the application buffer to the reconstruction buffer. The remaining areas of the reconstruction buffer are left empty (blank).

At 130, system user interface content is drawn into the application buffer. The system user interface content is drawn on top of the foreground application content in the application buffer. The system user interface content typically comprises one or more graphical user interface elements representing current status of the computing device, such as the current date and/or time, battery strength, wireless network signal strength, etc. However, the system user interface content is not limited to current system status information, and can include any type of graphical user interface content.

At 140, a composited frame is displayed by sending the application buffer directly to the display hardware of the computing device for display. The composited frame is the content of the application buffer (the foreground application content composited with the system user interface content on top). In a specific implementation, the application buffer is sent directly to the display hardware for display without making a further copy of the application buffer. Sending the application buffer directly for display (without copying it to another buffer) provides for more efficient display of composited application and system user interface content.

Using the example method 100, a foreground application can produce an arbitrary number of frames for display. In a specific implementation, when the foreground application is ready to draw a frame, the foreground application requests a new buffer from the graphics system (e.g., from a compositor) and draws its application content into the new buffer. The graphics system (e.g., the compositor) builds a reconstruction buffer from the new buffer and draws system user interface content into the new buffer on top of the application content already in the new buffer. The graphics system then displays the new buffer as a composited frame on the display. When the foreground application is ready to draw its next frame, the process repeats with the foreground application requesting another new buffer. In some situations, this type of updating (e.g., where the foreground application is producing new frames at the same rate as the system) is called synchronous updating.

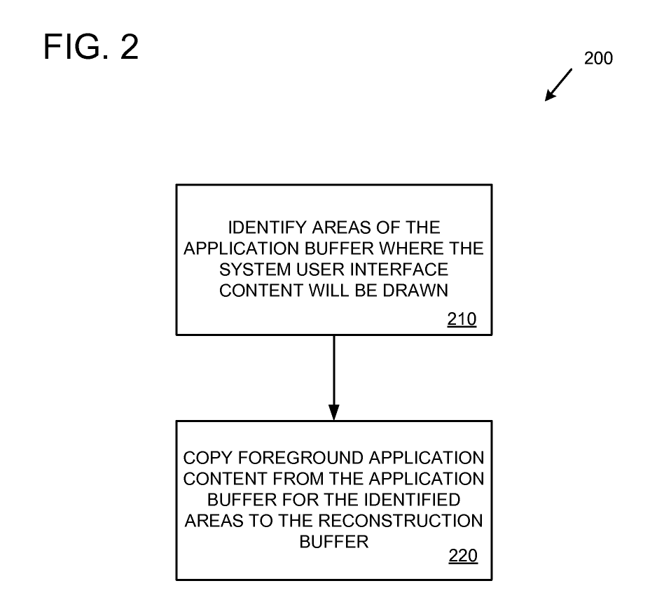

FIG. 2 shows an exemplary method 200 for building a reconstruction buffer. At 210, areas of the application buffer where the system user interface content will be drawn are identified. In a specific implementation, the areas where the system user interface content will overlay the foreground application content are identified using bounding rectangles.

At 220, the foreground application content for the identified areas (identified at 210) are copied, from the application buffer, to the reconstruction buffer. By copying the areas of foreground application content from the application buffer, the foreground application content can be later recreated after system user interface content has been drawn on top of the foreground application content.

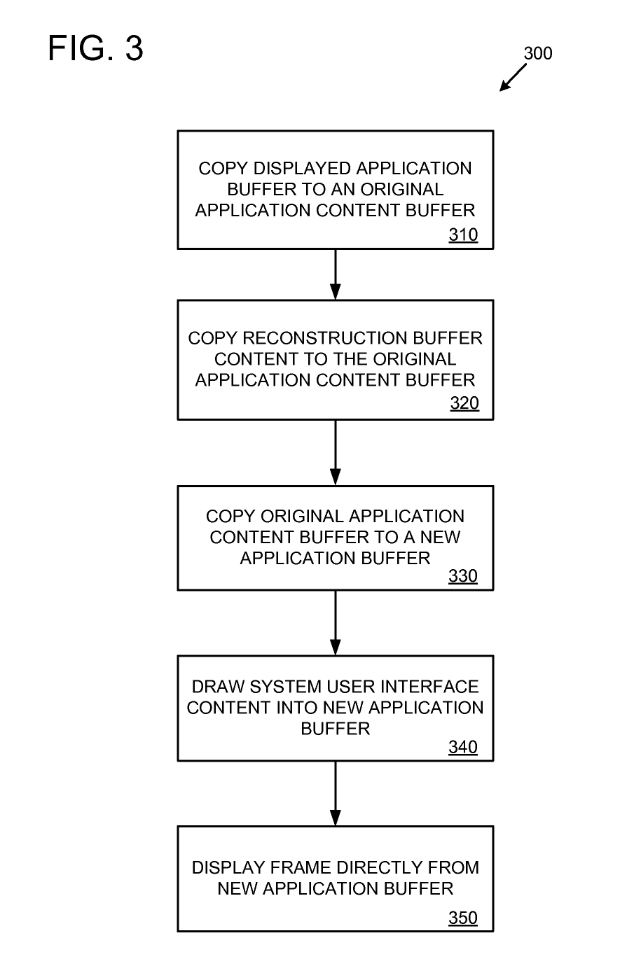

FIG. 3 shows an exemplary method 300 for updating system user interface content without updating application content. In contrast to the example method 100, which is driven by the foreground application updating its content, the example method 300 is driven by the system updating system user interface content without the application updating its content. For example, the method 300 may operate when the foreground application does not have any updated content to display, or when the foreground application is preparing updated application content but the updated application content is not yet ready or complete (e.g., the foreground application has not completed drawing into its application buffer). In either case, a number of reasons exist for updating system user interface content even when the application is not updating its content. One reason is to maintain updated system status information, such as the current system time, signal strength, battery level, or system user interface content that benefits from real-time, or near real-time, updates.

In the example method 300, the displayed application buffer is copied to a new buffer, called an original application content buffer 310. The displayed application buffer is the application buffer that was used to display the previous frame, and it contains the foreground application data with the system user interface content (e.g., the buffer created at 130 and displayed at 140). In a specific implementation, only portions of the foreground application content that will not be covered by the reconstruction buffer content are copied to the original application content buffer.

At 320, the reconstruction buffer content (e.g., the reconstruction buffer created at 120, or the reconstruction buffer built in the example method 200) is copied to the original application content buffer. In a specific implementation, only the portions of the foreground application content in the reconstruction buffer are copied to the original application content buffer. The reconstruction buffer content is copied on top of the existing content in the original application content buffer, which replaces the system user interface content in the original application content buffer. Therefore, the remaining content of the original application content buffer, after the reconstruction buffer content is copied, is only the foreground application content (with no system user interface content). In a specific implementation, the original application content buffer (after the reconstruction buffer content has been copied into it) is saved (e.g., cached) for use later.

At 330, the original application content buffer is copied to a new buffer (called a new application buffer). In a specific implementation, the original application content buffer is copied from the saved (e.g., cached) copy.

At 340, system user interface content is drawn into the new application buffer on top of the content already in the new application buffer (the foreground application content). The system user interface content is typically updated system user interface content. However, the example method 300 works regardless of whether the system user interface content is updated or not.

At 350 a composited frame is displayed by sending the new application buffer directly to the display hardware of the computing device for display. The composited frame is the content of the new application buffer (the foreground application content composited with the system user interface content on top). In a specific implementation, the new application buffer is sent directly to the display hardware for display without making a further copy of the new application buffer. By sending the new application buffer directly for display (without copying it to another buffer) the method provides for more efficient display of composited application and system user interface content.

Using the example method 300, system user interface content can be updated without updating foreground application content. In some situations, this type of updating (e.g., where the system is driving updates without application content being updated) is called asynchronously updating. In a specific implementation, when the graphics system is ready to update system user interface content and the foreground application is not updating content (e.g., it is running slowly and is not ready to update its content), the graphics system (e.g., the compositor) first needs to restore the original foreground application content by copying the last displayed application buffer to a new buffer (an original application content buffer). The graphics system then copies the reconstruction buffer content to the original application content buffer, restoring the foreground application content to the original application content buffer. Now that the graphics system has the foreground application content in the original application content buffer, any number of new frames can be displayed with updated system user interface content by copying the original application buffer content to a new buffer (a new application buffer), drawing updated system user interface content, on top, into the new application buffer, and displaying a new frame from the new application buffer.

V. Example Buffers

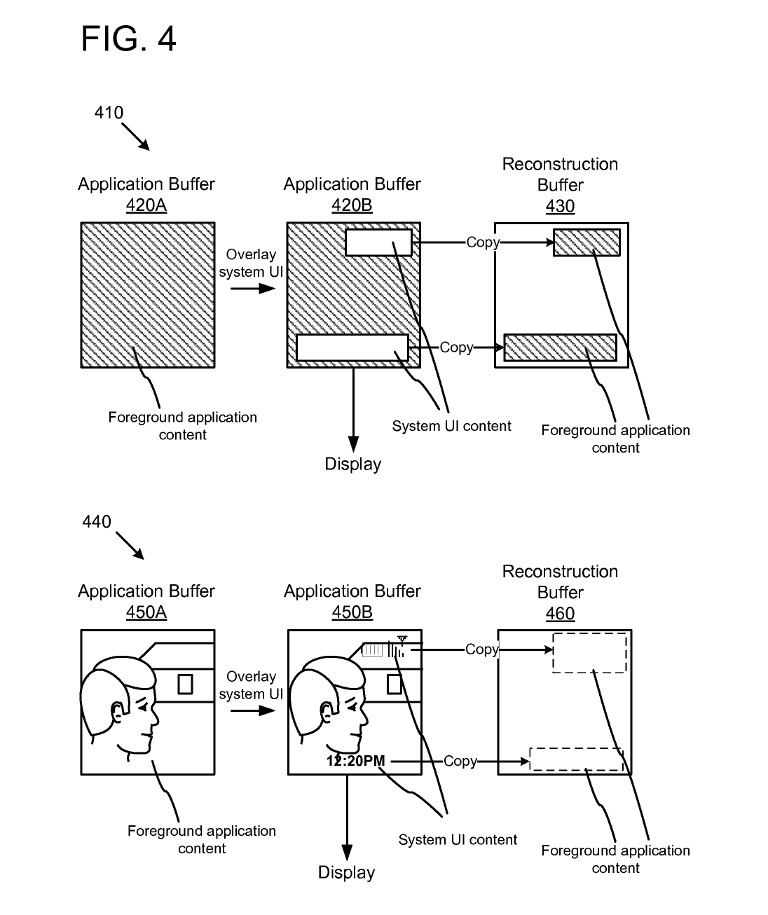

FIG. 4 depicts example buffers and related operations for compositing application content and system content for display. The buffers depicted at 410 are a generalized example of the process of creating the application buffer for display as well as the reconstruction buffer. At 420A, the application buffer is depicted. The application buffer 420A contains application content drawn by the foreground application.

After the foreground application draws its content into the application buffer 420A, the system draws system user interface (UI) content into the application buffer 420B. The system user interface content is drawn into the application buffer 420B on top of the foreground application content (e.g., as an overlay). Once the application buffer 420B has been composited (the foreground application data with the system user interface content), it is handed off to the graphics system for display without the need to create an additional copy of the application buffer 420B (e.g., the application buffer 420B can be handed off directly to the graphics hardware for display).

Before the system user interface content is drawn into the application buffer 420B, a reconstruction buffer 430 is created from the application buffer 420B. The reconstruction buffer 430 is built by copying areas of foreground application content from the application buffer 420B where the system user interface content will be drawn on top.

At 440, the same buffers are depicted (as depicted at 410), but contain representations of real-world content. The application buffer 450A depicts foreground application content drawn by an application such as a photo capture application or a movie application. The system user interface content is drawn into the application buffer 450B on top of the foreground application content. The specific system user interface content depicted in 450B is a battery indicator, a signal strength indicator, and the time. The reconstruction buffer 460 contains foreground application content from the application buffer 450B for areas that will be overlaid with the battery, signal strength, and time system user interface elements.

In a specific implementation, the example buffers and operations depicted in FIG. 4 are used when application-driven updates are being performed (e.g., synchronous updates). When application-driven updates are being performed, the foreground application is driving updates to the display (e.g., driving the framerate). System user interface content is drawn on top (either the same system user interface content or updated user interface content) when the foreground application draws into a new buffer for display (e.g., 420B and 450B).

In addition, the example buffers depicted in FIG. 4 reflect the buffers used by the method depicted in FIG. 1. Specifically, at 110, the foreground application draws its content into the application buffer (420A and 450A). At 120, the reconstruction buffer (430 and 460) is built. At 130, the system user interface content is drawn into the application buffer (420B and 450B). At 140, a frame is displayed directly from the application buffer (420B and 450B), as composited with the system user interface content on top of the foreground application content.

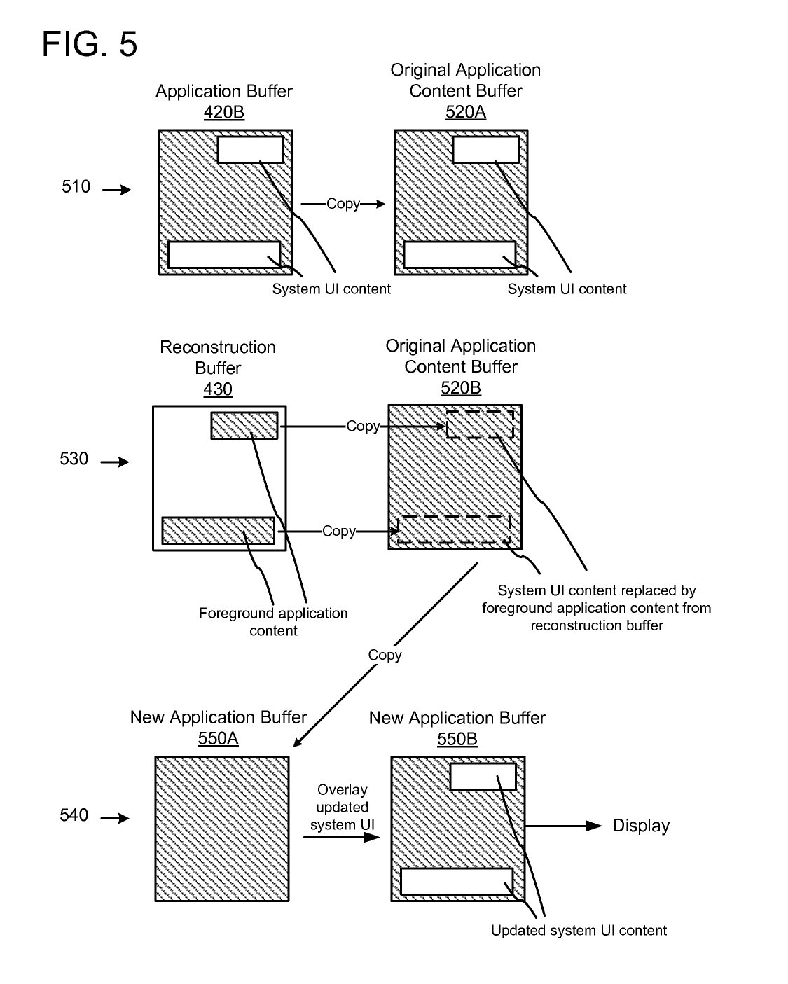

FIG. 5 depicts example buffers and related operations for compositing a frame for display where system user interface content is updated and application content remains the same. At 510, the previous buffer that was sent for display (the application buffer 420B) is copied to a new buffer (the original application content buffer 520A). At 530, the contents of the reconstruction buffer 430 (the foreground application content for those areas that were overwritten by the system user interface content) are copied to the original application content buffer 520B. As depicted in the original application content buffer 520A and 520B, the system user interface content is replaced by the foreground application content from the reconstruction buffer 430. The resulting original application content buffer 520B contains only the foreground application content. The original application content buffer 520B can be saved (e.g., cached) for use in later displaying any number of composited frames with updated system user interface content using the same (non-updated) foreground application content.

At 540, the original application content buffer 520B is copied to a new buffer 550A (a new application buffer). The system user interface content (e.g., updated system user interface content) is drawn into the new application buffer 550B on top. Once the new application buffer 550B has been composited (the foreground application data with the system user interface on top), it is handed off to the graphics system for display without the need to create an additional copy of the new application buffer 550B (e.g., the new application buffer 550B can be handed off directly to the graphics hardware for display).

In a specific implementation, the example buffers and operations depicted in FIG. 5 are used when system-driven updates (e.g., compositor-driven updates) are being performed (e.g., asynchronous updates). When system-driven updates are being performed, system user interface updates are driving updates to the display (e.g., driving the framerate). For example, this situation can occur when the foreground application is not updating its content but the system needs to update system user interface content (e.g., battery strength, signal strength, or current time). This situation can also occur when the foreground application is updating its content slowly (e.g., slower than a threshold framerate).

In addition, the example buffers depicted in FIG. 5 reflect the buffers used by the method depicted in FIG. 3. Specifically, at 310, the displayed application buffer (420B) is copied to an original application content buffer (520A). At 320, the reconstruction buffer content (430) is copied to the original application content buffer (520B). At 330, the original application content buffer is copied to a new application buffer (550A). At 340, system user interface content is drawn into the new application buffer (550B). At 350, a frame is displayed directly from the new application buffer (550B), as composited with the system user interface content on top of the foreground application content.

The term “buffer,” as used herein, refers to graphics buffers (e.g., frame buffers) that store graphical content (e.g., pixel data) for display by graphics hardware and/or software of a computing device.

VI. Example Mobile Devices

The techniques and solutions described herein can be performed by software and/or hardware of a computing device, such as a mobile device (a mobile computing device). For example, computing devices include desktop computers, laptop computers, notebook computers, netbooks, tablet devices, and other types of computing devices. Mobile devices include, for example, mobile phones, personal digital assistants (PDAs), smart phones, tablet computers, laptop computers, and other types of mobile computing devices. Mobile devices often have more limited computing resources (e.g., processing unit speed, memory, graphics resources, etc.) than other types of computing devices (e.g., a desktop or laptop computer). Therefore, in some situations, mobile devices benefit more from the techniques and solutions described here. However, depending on implementation details, any type of computing device can benefit from the techniques and solutions described herein.

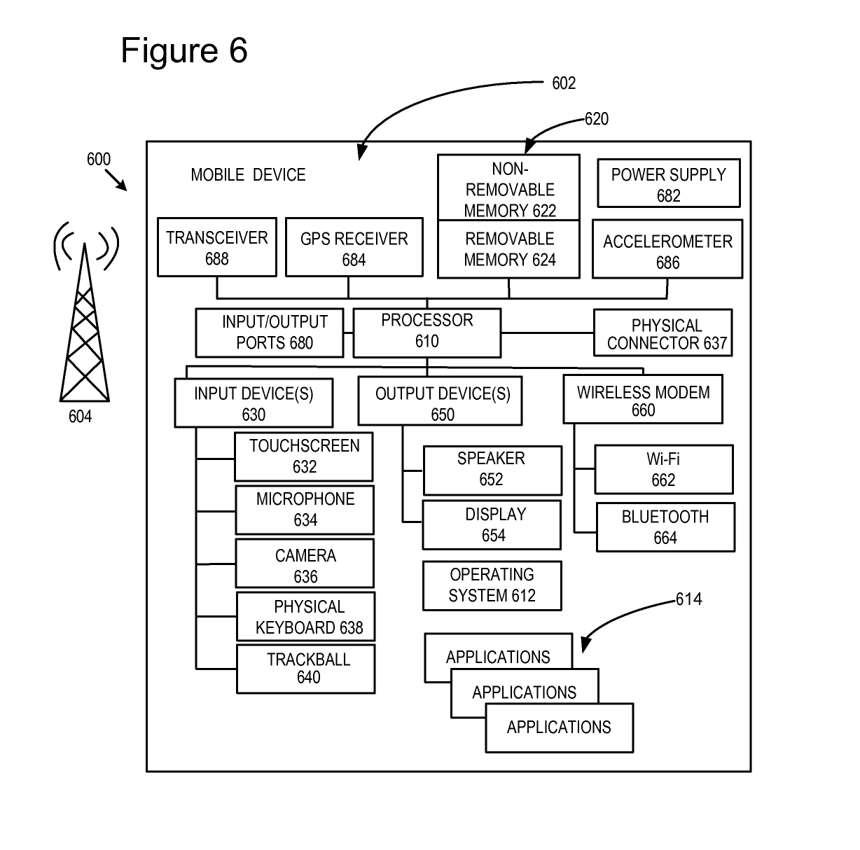

FIG. 6 depicts a detailed example of a mobile device 600 capable of implementing the techniques and solutions described herein. The mobile device 600 includes a variety of optional hardware and software components, shown generally at 602. Any components 602 in the mobile device can communicate with any other component, although not all connections are shown, for ease of illustration. The mobile device can be any of a variety of computing devices (e.g., cell phone, smartphone, handheld computer, laptop computer, notebook computer, tablet device, netbook, Personal Digital Assistant (PDA), camera, video camera, etc.) and can allow wireless two-way communications with one or more mobile communications networks 604, such as a Wi-Fi, cellular, or satellite network.

The illustrated mobile device 600 can include a processing unit (e.g., controller or processor) 610, such as a signal processor, microprocessor, ASIC, or other control and processing logic circuitry, for performing such tasks as signal coding, data processing, input/output processing, power control, and/or other functions. An operating system 612 can control the allocation and usage of the components 602 and support for one or more application programs 614. The application programs can include common mobile computing applications (e.g., email applications, calendars, contact managers, web browsers, messaging applications, video or movie applications, picture or photo applications), or any other computing application.

The illustrated mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. The memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 600 can support one or more input devices 630, such as a touch screen 632, microphone 634, camera 636 (e.g., capable of capturing still pictures and/or video images), physical keyboard 638 and/or trackball 640 and one or more output devices 650, such as a speaker 652 and a display 654. Other possible output devices (not shown) can include piezoelectric or other haptic output devices. Some devices can serve more than one input/output function. For example, touch screen 632 and display 654 can be combined in a single input/output device.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, an accelerometer 686, a transceiver 688 (for wirelessly transmitting analog or digital signals) and/or a physical connector 637, which can be a USB port, IEEE 1394 (FireWire) port, and/or RS-232 port. The illustrated components 602 are not required or all-inclusive, as any components can be deleted and other components can be added.

The mobile device 600 can implement the technologies described herein. For example, the processing unit 610 (alone or in combination with other hardware and/or software of the mobile device, such as the operating system 612 and the applications 614) can perform operations such drawing foreground application content into application buffers, building reconstruction buffers, drawing system user interface content into application buffers, and displaying application buffers on the display 654 as composited frames.

VII. Example Implementation Environment

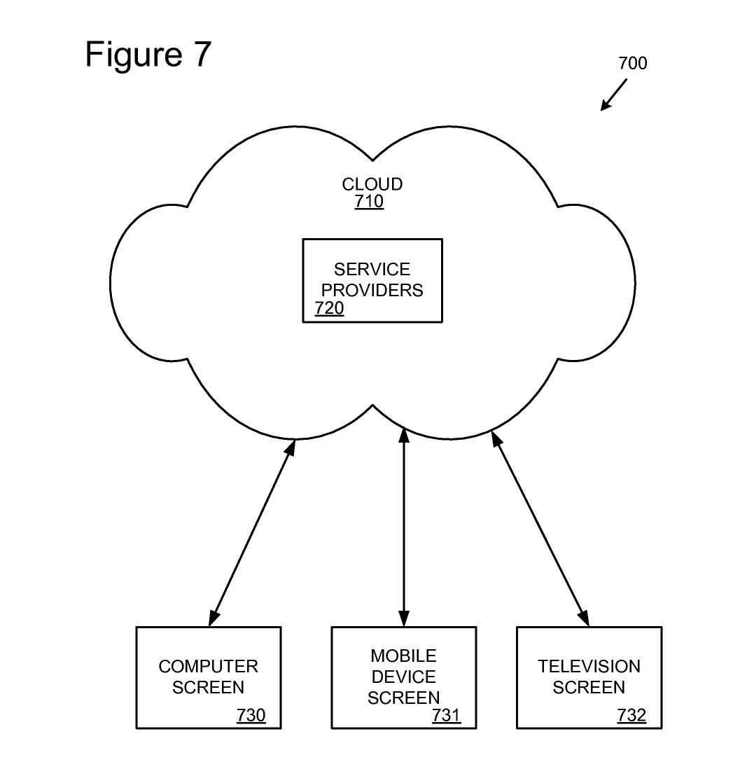

FIG. 7 illustrates a generalized example of a suitable implementation environment 700 in which described embodiments, techniques, and technologies may be implemented.

In example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730-732) while other tasks (e.g., storage of data to be used in subsequent processing) can be performed in the cloud 710.

In example environment 700, the cloud 710 provides services for connected devices 730-732 with a variety of screen capabilities. Connected device 730 represents a device with a computer screen (e.g., a mid-size screen). For example, connected device 730 could be a personal computer such as desktop computer, laptop, notebook, netbook, or the like. Connected device 731 represents a device with a mobile device screen (e.g., a small size screen). For example, connected device 731 could be a mobile phone, smart phone, personal digital assistant, tablet computer, and the like. Connected device 732 represents a device with a large screen. For example, connected device 732 could be a television screen (e.g., a smart television) or another device connected to a television (e.g., a set-top box or gaming console) or the like. One or more of the connected devices 730-732 can include touch screen capabilities. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touch screen capability of a particular connected device (e.g., connected devices 730-732).

VIII. Example Alternatives and Variations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable media (tangible computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. We therefore claim as our invention all that comes within the scope and spirit of these claims.

We claim:

1. A method, implemented at least in part by a computing device, for compositing application content and system content to create a first composited frame for display, the method comprising:
drawing foreground application content into an application buffer;
building a reconstruction buffer, wherein the reconstruction buffer contains portions of the foreground application content copied from the application buffer;
drawing system user interface content on top of the foreground application content in the application buffer;
copying the application buffer to an original application content buffer;
copying the portions of the foreground application content from the reconstruction buffer into the original application content buffer, wherein the original application content buffer, after copying the content of the reconstruction buffer, contains only the foreground application content; and
displaying, by the computing device, the first composited frame by sending the application buffer directly to display hardware of the computing device for display.

2. The method of claim 1 wherein the building the reconstruction buffer comprises:
identifying areas of the application buffer where the system user interface content will be drawn; and
copying foreground application content from the application buffer for the identified areas to the reconstruction buffer;
wherein the reconstruction buffer, after the copying, contains foreground application content only for the identified areas where the system user interface content will be drawn.

3. The method of claim 2 wherein the identifying areas of the application buffer where the system user interface content will be drawn is performed using bounding rectangles.

4. The method of claim 1 wherein the application buffer is sent directly to the display hardware for display without making a further copy of the application buffer.

5. The method of claim 1 wherein the drawing the system user interface content into the application buffer comprises drawing one or more system user interface elements into the application buffer, where the one or more system user interface elements are drawn on top of the foreground application content in the application buffer.

6. The method of claim 1 wherein the copying the application buffer to the original application content buffer is performed after sending the application buffer for display.

7. The method of claim 1 further comprising:
displaying, by the computing device, one or more additional composited frames, wherein displaying each additional composited frame comprises:
copying the original application content buffer to a new application buffer;
drawing updated system user interface content into the new application buffer; and
displaying, by the computing device, the additional composited frame by sending the new application buffer directly to the display hardware of the computing device for display.

8. The method of claim 7 wherein the displaying the one or more additional composited frames is performed when system user interface content is changing and the foreground application content remains the same.

9. A mobile device for compositing application content and system content to create a first composited frame for display, the mobile device comprising:
a display; and
a processing unit, wherein the processing unit is configured for performing operations comprising:
drawing foreground application content into an application buffer;
building a reconstruction buffer, wherein the reconstruction buffer contains portions of the foreground application content copied from the application buffer;
drawing system user interface content on top of the foreground application content in the application buffer;
copying the application buffer to an original application content buffer;
copying the portions of the foreground application content from the reconstruction buffer into the original application content buffer, wherein the original application content buffer, after copying the content of the reconstruction buffer, contains only the foreground application content; and
displaying, by the mobile device on the display, the first composited frame by sending the application buffer directly to display hardware of the mobile device for display.

10. The mobile device of claim 9 wherein the building the reconstruction buffer comprises:
identifying areas of the application buffer where the system user interface content will be drawn; and
copying foreground application content from the application buffer for the identified areas to the reconstruction buffer;
wherein the reconstruction buffer, after the copying, contains foreground application content only for the identified areas where the system user interface content will be drawn.

11. The mobile device of claim 10 wherein the identifying areas of the application buffer where the system user interface content will be drawn is performed using bounding rectangles.

12. The mobile device of claim 9 wherein the application buffer is sent directly to the display hardware for display without making a further copy of the application buffer.

13. The mobile device of claim 9 wherein the drawing the system user interface content into the application buffer comprises drawing one or more system user interface elements into the application buffer, where the one or more system user interface elements are drawn as overlays to the foreground application content in the application buffer.

14. The mobile device of claim 9 wherein the copying the application buffer to the original application content buffer is performed after sending the application buffer for display.

15. The mobile device of claim 9 further comprising:
displaying, by the mobile device, one or more additional composited frames, wherein displaying each additional composited frame comprises:
copying the original application content buffer to a new application buffer;
drawing updated system user interface content into the new application buffer; and
displaying, by the mobile device on the display, the additional composited frame by sending the new application buffer directly to the display hardware of the mobile device for display.

16. The mobile device of claim 15 wherein the displaying the one or more additional composited frames is performed when system user interface content is changing and the foreground application content remains the same.

17. A method, implemented at least in part by a computing device, for compositing application content and system content to create composited frames for display, the method comprising:
creating a first composited frame for display, comprising:
drawing foreground application content into an application buffer;
building a reconstruction buffer, wherein the reconstruction buffer contains portions of the foreground application content copied from the application buffer;
drawing system user interface content on top of the foreground application content in the application buffer; and
displaying, by the computing device, the first composited frame by sending the application buffer directly to display hardware of the computing device for display; and
creating a second composited frame for display, comprising:
after sending the application buffer for display, copying the application buffer to an original application content buffer;
copying the portions of the foreground application content from the reconstruction buffer into the original application content buffer, wherein the original application content buffer, after copying the content of the reconstruction buffer, contains only the foreground application content;
copying the original application content buffer to a new application buffer;
drawing updated system user interface content, on top, into the new application buffer; and
displaying, by the computing device, the second composited frame by sending the new application buffer directly to the display hardware of the computing device for display.

18. The method of claim 17 wherein the creating the second composited frame for display is performed when the foreground application is producing fewer frames per second than a threshold value.

19. The method of claim 17 wherein the creating the second composited frame for display is performed when the foreground application content remains unchanged.

20. The method of claim 17 wherein the application buffer is sent directly to the display hardware for display without making a further copy of the application buffer, and wherein the new application buffer is sent directly to the display hardware for display without making a further copy of the new application.
